(19) United States
(12) Patent Application Publication
(10) Pub. No.: US 2007/0005587 A1
(43) Pub. Date: Jan. 4, 2007

(54) Relative search results based off of user interaction

(75) Inventors: Jeffrey Austin Johnson, Redmond, WA (US); Matthew Bryan Jeffries, Kirkland, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/172,464

(22) Filed: Jun. 30, 2005

(51) Int. Cl. G06F 17/30

(52) U.S. Cl. 707/5

(57) ABSTRACT

A program product and method is disclosed that rely on user interaction in the ordering of search results returned by a search engine. Each of a plurality of records in a database is associated with a user-interaction parameter that is associated with the duration of time that a user accesses a particular record of the search result. Provided that the duration of time that the user accesses the record is greater than a predetermined relevant time period, the user-interaction parameter is weighted to increase the relevance of this record in relation to records that did were not accessed for the relevant time period used in ordering the records identified in a result set generated in response to a search request.

### TECHNICAL FIELD

The invention relates generally to computers and computer software. More specifically, this invention relates generally to search engines and the user's interaction with a result set generated thereby.

### BACKGROUND OF THE INVENTION

Search engines are generally computer programs that are used to access databases of information in response to queries submitted by users. Search engines are commonly used to access a wide variety of databases and sift through the information to find relevant information in response to the search query.

A predominant application of search engines is in accessing information from the Internet. For example, a search engine is often used to access directory services to identify documents that contain information about particular topics. With directory services, documents are typically classified by topic, with the addresses of those documents, as well as basic summaries thereof, stored in records that are searchable by the search engine.

Search engines are also often used to access indexing services that attempt to catalog as many documents as possible from the Internet. Most indexing services typically construct databases of document records by reading documents on the Internet, cataloging important terms and words therefrom, and following any links provided in each document to locate additional documents.

As the number of located documents increases, the order in which those documents are presented to a user, also referred to as the “ranking” of the documents, becomes more important, as a user will typically look at the documents identified at the top of a list of search results before looking at documents identified later in the results.

Early search engines typically relied on generally rudimentary retrieval algorithms that ranked the results of queries based upon factors such as the number of search terms that were found in each document, the number of occurrences of each search term in each document, the proximity of search terms in each document, and/or the location of search terms in each document (e.g., giving greater weight to search terms being at the top, or in a title or heading, or a document). However, it has been found that ranking results purely by the placement and frequency of search terms often leads to poor rankings. As one example, some conventional search engines can be manipulated by document authors through a process known as “spamming”, where search terms are inserted into documents in non-visible portions thereof for no other purpose but to increase relative rankings of the documents given by search engines.

To address such concerns, some conventional search engines rely on additional information to rank results. For example, the search engines for some indexing services weight documents more heavily based upon whether the documents are also listed in associated directory services. Other search engines use “link popularity” to rank results, granting higher rankings to documents that are linked to by other documents.

While the above-described enhancements to conventional search engines have been successful to an extent in providing users with more relevant search results, a significant need continues to exist for further improvements in the manner in which search results are ordered and returned to users. In particular, it is believed that additional gains in the relevancy and usability of the results returned by search engines may be obtained through reliance on the interaction of users with particular documents in the ordering of search results.

### SUMMARY OF THE INVENTION

The invention addresses these and other problems associated with the prior art by providing a number of program products and methods that rely on previous user interaction in the ranking of search results returned by a search engine. Consistent with the invention, each of a plurality of records in a database is associated with a user-interaction parameter that is used in ordering the records identified in a result set generated in response to a search request. The manner in which the user-interaction parameter is configured, updated and utilized in ranking search results, however, can vary in different applications.

For example, consistent with one aspect of the invention, the user-interaction parameter for a given record may be selectively updated in response to detecting the length of time a user accesses a particular record. The value of this type of interaction mechanism is based upon the assumption that a user remains on a particular record longer if that particular record has relevant information pertinent to the particular search request.

Consistent with a further aspect of the invention, the user-interaction parameter for a given record may be selectively updated in response to detecting that the length of time a user accesses a particular record exceeds a pre-determined relevant time-period. The value of this type of interaction mechanism is based upon the assumption that if a user remains on a particular record for longer that the pre-determined relevant time period, it is a good indication that the particular record has relevant information pertinent to the particular request.

Consistent with another aspect of the invention, the user-interaction parameter for a given record may be selectively updated in response to detecting that a lower-ranked record was accessed for a pre-determined relevant length of time. The value of this type of interaction mechanism is based upon the assumption that a higher ranked, but non-accessed record or a higher-ranked record that was not accessed for the pre-determined length of time is less relevant than a later accessed record if the later-accessed record is accessed for the predetermined length of time.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE SEVERAL VIEWS OF THE DRAWINGS

FIG. 1 is a block diagram of a networked computer system consistent with the invention.

FIG. 2 is a block diagram of an exemplary hardware and software environment for the networked computer system of FIG. 1.

FIG. 3 is a block diagram of the operations that occur during interaction with a search engine in the computer system of FIG. 2.

FIG. 4 is a flowchart illustrating the program flow of a main routine for a browser of FIG. 2 for a server-implementation of the present invention.

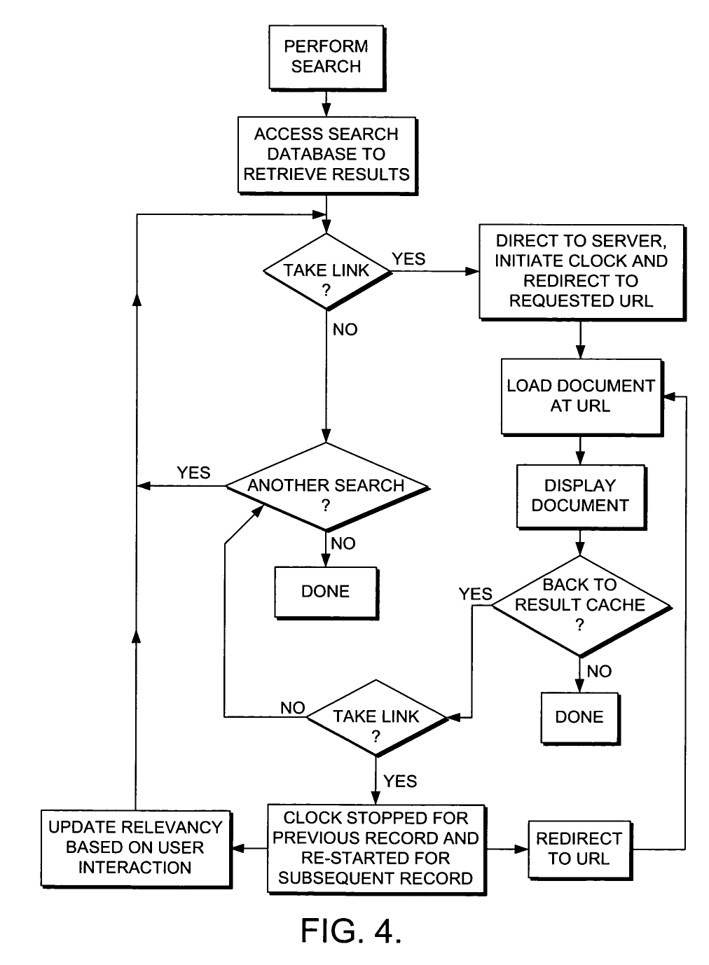

FIG. 5 is a block diagram illustrating the program flow of a main routine for the search engine of FIG. 2 for a server-implementation of the present invention.

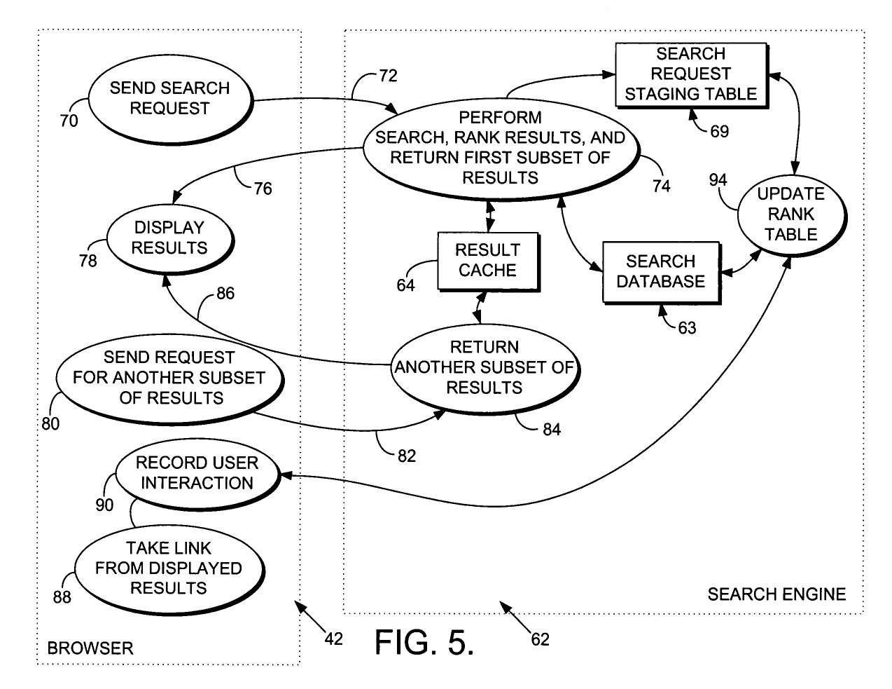

FIG. 6 is a flowchart illustrating the program flow of a main routine for a browser of FIG. 2 for a browser-implementation of the present invention.

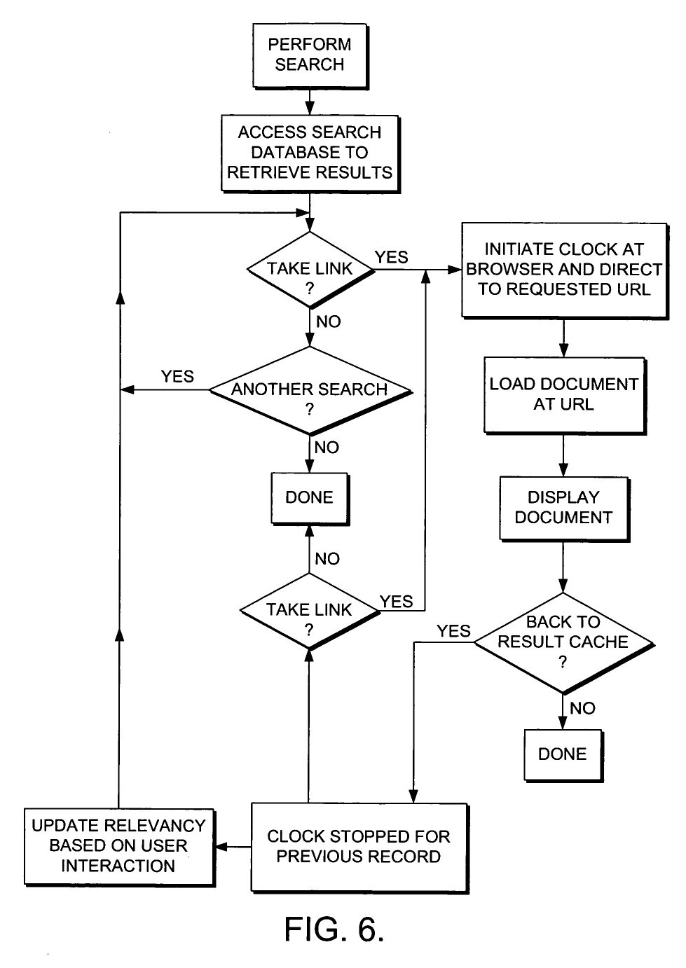

FIG. 7 is a flowchart illustrating the program flow of a main routine for a browser of FIG. 2 for a browser-implementation of the present invention having a clickthrough user interaction.

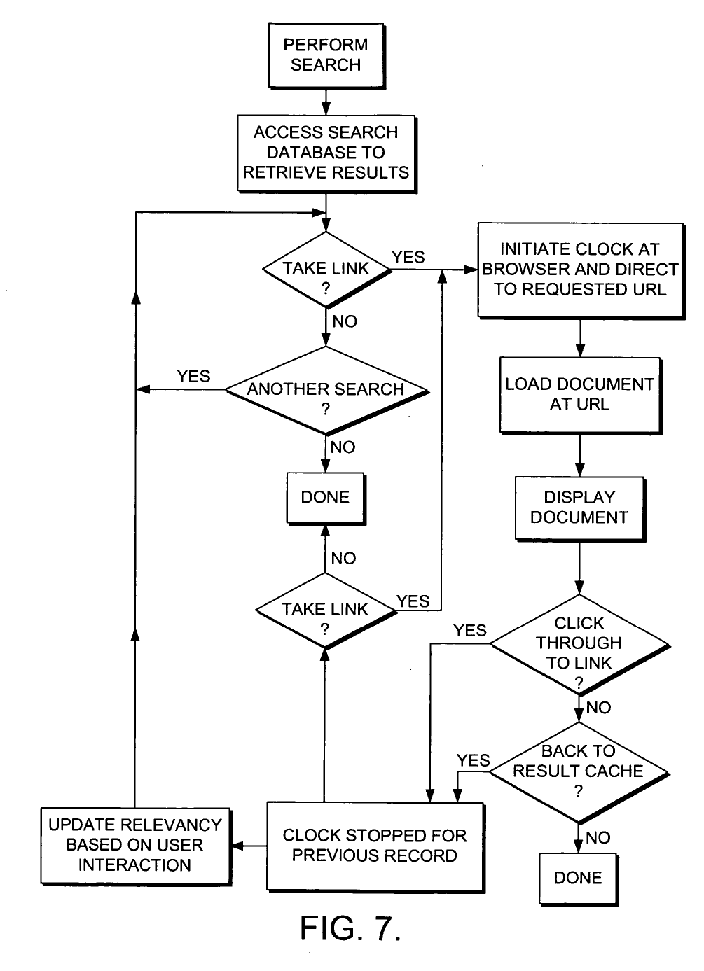

### DETAILED DESCRIPTION OF THE INVENTION

Hardware and Software Environment

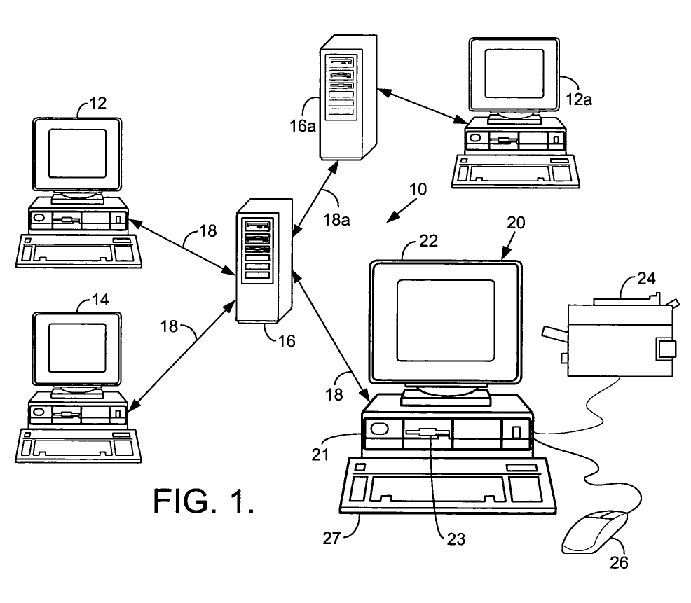

Turning to the Drawings, wherein like numbers denote like parts throughout the several views, FIG. 1 illustrates a computer system 10 consistent with the invention. Computer system 10 is illustrated as a networked computer system that defines a multi-user computer environment, and that includes one or more client computers 12, 14 and 20 (e.g., desktop or PC-based computers, workstations, etc.) coupled to server 16 (e.g., a PC-based server, a minicomputer, a midrange computer, a main-frame computer, etc.) through a network 18. Also illustrated is an additional server 16a interfaced with server 16 over a network 18a, and to which is coupled a client computer 12a. Networks 18 and 18a may represent practically any type of networked interconnection, including but not limited to local-area, wide-area, wireless, and public networks (e.g., the Internet). Moreover, any number of computers and other devices may be networked through networks 18, 18a, e.g., additional client computers and/or servers.

Client computer 20, which may be similar to computers 12, 12a and 14, typically includes a central processing unit (CPU) 21; a number of peripheral components such as a computer display 22; a storage device 23; a printer 24; and various input devices (e.g., a mouse 26 and keyboard 27), among others. Server computers 16, 16a may be similarly configured, albeit typically with greater processing performance and storage capacity, as is well known in the art.

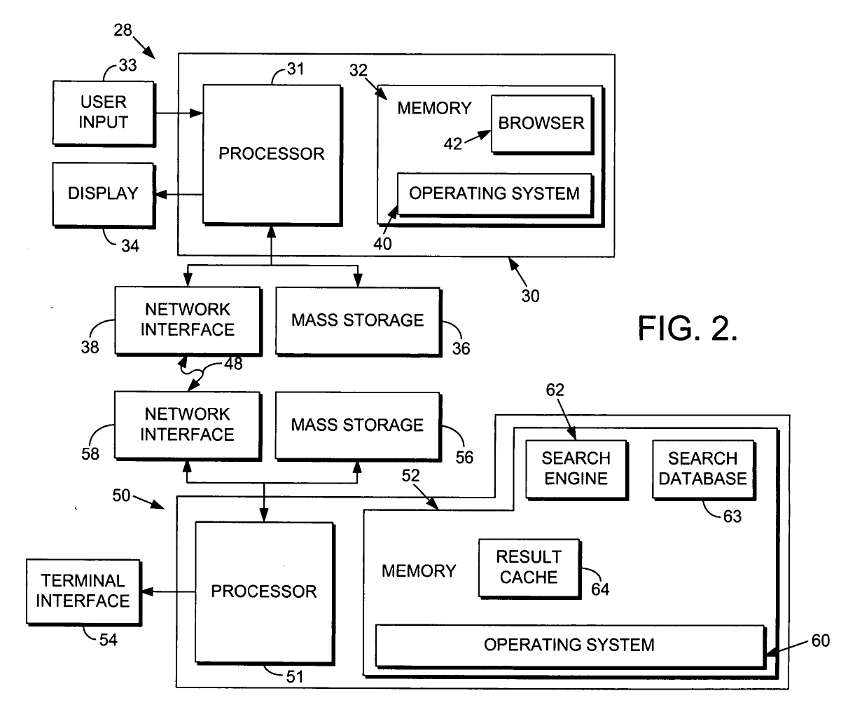

FIG. 2 illustrates in another way an exemplary hardware and software environment for networked computer system 10, including an apparatus 28 which includes a client apparatus 30 interfaced with a server apparatus 50 via a network 48. For the purposes of the invention, client apparatus 30 may represent practically any type of computer, computer system or other programmable electronic device capable of operating as a client, including a desktop computer, a portable computer, an embedded controller, etc. Similarly, server apparatus 50 may represent practically any type of multi-user or host computer system. Each apparatus 28, 30 and 50 may hereinafter also be referred to as a “computer” or “computer system”, although it should be appreciated the term “apparatus” may also include other suitable programmable electronic devices consistent with the invention.

Computer 30 typically includes at least one processor 31 coupled to a memory 32, and computer 50 similarly includes at least one processor 51 coupled to a memory 52. Each processor 31, 51 may represent one or more processors (e.g., microprocessors), and each memory 32, 52 may represent the random access memory (RAM) devices comprising the main storage of the respective computer 30, 50, as well as any supplemental levels of memory, e.g., cache memories, non-volatile or backup memories (e.g., programmable or flash memories), read-only memories, etc. In addition, each memory 32, 52 may be considered to include memory storage physically located elsewhere in the respective computer 30, 50, e.g., any cache memory, or any storage capacity used as a virtual memory such as in a mass storage device or on another computer coupled to the respective computer 30, 50 via an external network.

Each computer 30, 50 also typically receives a number of inputs and outputs for communicating information externally. For interface with a user or operator, computer 30 typically includes one or more user input devices 33 (e.g., a keyboard, a mouse, a trackball, a joystick, a touchpad, and/or a microphone, among others) and a display 34 (e.g., a CRT monitor, an LCD display panel, and/or a speaker, among others). Likewise, user interface with computer 50 is typically handled via a terminal coupled to a terminal interface 54.

For additional storage, each computer 30, 50 may also include one or more mass storage devices 36, 56, e.g., a floppy or other removable disk drive, a hard disk drive, a direct access storage device (DASD), an optical drive (e.g., a CD drive, a DVD drive, etc.), and/or a tape drive, among others. Furthermore, each computer 30, 50 may include an interface with one or more networks via a network interface 38, 58 (e.g., a LAN, a WAN, a wireless network, and/or the Internet, among others) to permit the communication of information with other computers coupled to the network.

Computer 30 operates under the control of an operating system 40, and executes or otherwise relies upon various computer software applications, components, programs, objects, modules, data structures, etc. (e.g., browser 42).

Likewise, computer 50 operates under the control of an operating system 60, and executes or otherwise relies upon various computer software applications, components, programs, objects, modules, data structures, etc. (e.g., search engine 62, search database 63, result cache 64, taken link staging table 68 and search request staging table 69). Moreover, various applications, components, programs, objects, modules, etc. may also execute on one or more processors in another computer coupled to either of computers 30, 50, e.g., in a distributed or client-server computing environment.

In general, the routines executed to implement the embodiments of the invention, whether implemented as part of an operating system or a specific application, component, program, object, module or sequence of instructions will be referred to herein as “computer programs”, or simply “programs”. The computer programs typically comprise one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tapes, optical disks (e.g., CD-ROM's, DVD's, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Those skilled in the art will recognize that the exemplary environments illustrated in FIGS. 1 and 2 are not intended to limit the present invention. Indeed, those skilled in the art will recognize that other alternative hardware and/or software environments may be used without departing from the scope of the invention.

Search Result Ordering Based on User Interaction

The embodiments illustrated herein generally operate by enhancing the generation and ordering of search results from a search engine in response to user interaction with the records comprising the search results. Furthermore, in the illustrated embodiment, the database accessed by the search engine is representative of an Internet-base utilized in connection with an indexing algorithm, and storing a plurality of records reflective of hypertext markup language (HTML-compatible documents stored on a network such as the Internet and/or a private network). As will be readily apparent to one of ordinary skill in the art, each record in the database includes at least an address of an associated document stored on a network, typically in the form of a uniform resource located (URL).

While the illustrated implementations focus on the above-described Internet-based application, it will be appreciated that in the techniques described herein may be utilized in connection with enhancing the retrieval of data from any type of database. Therefore, the invention is not limited to the particular HTML-based implementation discussed herein.

The illustrated implementation relies on a “user-interaction parameter” that associates with each record in the database information pertaining to interaction of one or more users with the record. The user-interaction parameter associated with each record includes one or more weights used to provide a ranking for a record relative to other records located in response to a search request.

For example, the relative weights of records in a result set may be the sole basis for ranking and ordering the members of the result set. Or, user interaction may be but one component used in ordering search results. Specifically, the primary manner of ordering search results is the perceived relevance of each record in terms of the degree in which each record matches the search request. For this primary ordering operation, any number of search engine parameters, e.g., the number of matching search terms, the proximity of search terms, the placement of search terms, the frequency of occurrence of each search term, etc., may be used. User interaction is utilized as an additional or secondary ordering parameter to assist in the ordering of records having like relevancies.

It will further be appreciated that additional parameters may also be utilized in connection with user interaction to assist in ordering records in a result set. For example, other conventional parameters such as link popularity, presence on an associated directory listing, etc., may also be used.

Herein are two exemplary implementations of the user-interaction parameter: server-side implementation and user-side implementation.

Server-Side Implementation

For server-side implementation, a search engine or web server may include tracking functionality consistent with the invention to generally support the two primary operations for use in performing user-interaction based ordering of search results. One operation is the initiation of a search request to return a result set that identifies one or more records from the database that matched the search request. A second operation is user interaction with the records in the result set, used to track user interaction with such records for the purpose of building a database of user-interaction information for use in ordering future result sets.

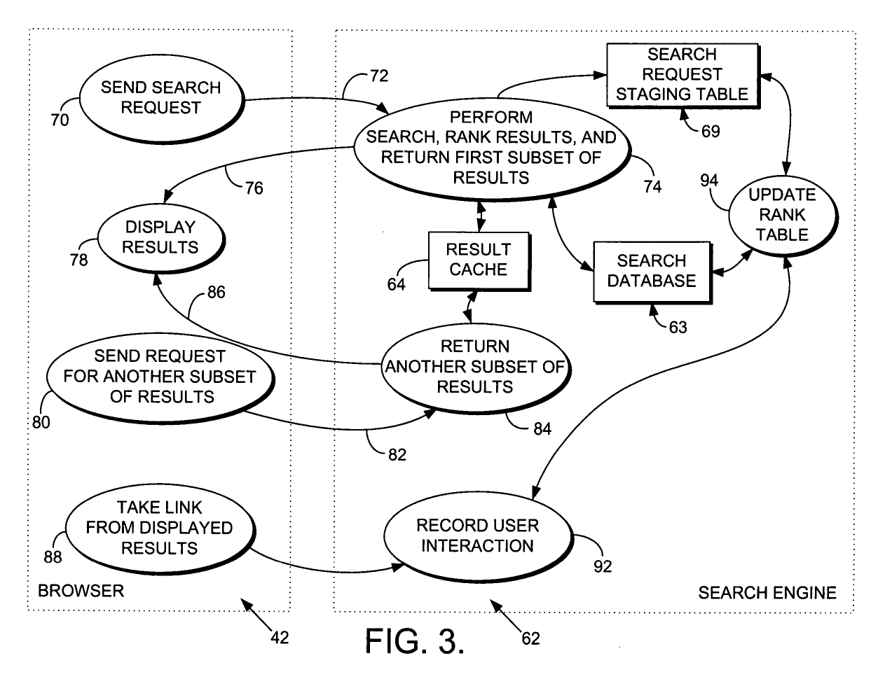

FIG. 3 illustrates the general operations handled by search engine 62 in response to requests from a user operating browser 42. As illustrated at block 70, for example, a user may initiate and send a search request 72 to search engine 62. In response to a search request, search engine 62 performs the search, ranks the results and returns a first subset of the results to the user, as represented at 76. The subset of results is displayed to the user in browser 42 as represented at 78 and include hypertext links pointing to server for the search engine 62 such that the search engine can detect user selection of a particular link in the subset of results. The server automatically forward the user to the requested result document.

A result cache 64 is typically utilized to store subsets of the results returned in response to a search request, such that the search database does not need to be re-queried whenever a user desires to view other results from a results set. In the illustrated implementation, the search engine constructs hypertext documents representing the subsets of results, e.g., with each hypertext document including hypertext links to a subset of records identified in response to the search request.

Upon re-direction to a particular link, the search engine initiates a clock or alternatively time stamps the link to associate a starting time for the user interacting with a particular document, and further determines the numeric ranking of the accessed link (e.g., search result number 4 out of 25 relevant documents). The search engine 62 continues the clock for the link until selection of an alternative link by the user. Upon selecting an alternative hypertext link from a result set, the server calculates the time differential between re-direction to the previous link and re-direction to the subsequent link to determine substantially the duration of time the record was reviewed. Further, the clock is initiated for the subsequent resulting link for the purpose of obtaining access time data for the subsequent link and the subsequent link's ranking is stored. This is continued until the interaction with the result cache is completed.

The server evaluates and assigns weights to the user-interaction parameter data associated with each record to assist in ordering subsequent search results. The server assigns a relevancy weight for each record that was accessed for longer than a pre-determined time (e.g., five minutes). Further, each record that has a higher ranking number than a “relevant accessed record” (i.e., a record that was accessed for a period of time that exceeded the pre-determined time criteria) and was either not accessed or was accessed and did not meet the pre-determined relevancy time criteria, may be degraded in the rankings or otherwise would get a non-relevant weight parameter. These parameters are stored in the search database 63. It will be appreciated, however, that the user-interaction parameter data stored in the search database may be stored in a separate data structure in the alternative.

Search engine 62 periodically updates the user interaction information stored in search database 63. As a consequence, over time, it is anticipated that search database 63 will develop a more useful indication of the longest accessed, and presumably most relevant documents represented by the records in the search database.

User-Side Implementation

The user-interaction parameter likewise may be implemented through a user-based application, such as the user's browser. A computer program 90 on the user's browser could be utilized to track user interaction with records, with the computer program providing notifications to the search engine on a periodic basis. This program could be resident on the user's computer or could be integrated into the browser, e.g., as a plug in or customization thereof, or downloaded to the user's computer.

In this implementation, a user may initiate and send a search request 72 to search engine 62. In response to a search request, search engine 62 performs the search, ranks the results and returns a first subset of the results to the user, as represented at 76. The subset of results is displayed to the user in browser 42 as represented at 78 and includes hypertext links to the relevant documents. Upon selection of a particular link, the user's browser 42 initiates an internal timing device or clock, and determines the numeric ranking of the accessed link (e.g., search result number 4 out of 25 relevant documents). Upon the user navigating away from the link, for example by clicking the “back” icon, clicking to another link, clicking home, or closing the browser, the browser stops the clock and stores the duration of time the record was accessed. This is continued until the interaction with the result cache 64 is completed. The browser thus stores user interaction data for each record accessed in the result cache. The interaction data consists of the duration of time the record was accessed and the ranking of the one or more documents accessed in the result cache.

If the user clicks a link in an accessed document, the browser initiates the internal timing device. Upon the user navigating away from the link or some time thereafter, the duration of time this secondary record was accessed is determined and the browser uploads the secondary record identification and time duration information to the server. The server determines whether the secondary matches a result of the result cache 64. If so, the duration of time this secondary record was accessed is compared to a pre-determined relevant time period of interaction. And, an interaction data set is created for this secondary record to increase or decrease its relevancy weight upon subsequent search queries.

Periodically, such as at the end of the user's interaction with the result cache, the browser notifies the server of the interaction data. The server evaluates and assigns weights to the user-interaction parameter data associated with each record to assist in ordering subsequent search results. The server assigns a relevancy weight for each record that was accessed for longer than a pre-determined time (e.g., five minutes). Further, each record that has a higher ranking number than a “relevant accessed record” (i.e., a record that was accessed for a period of time that exceeded the pre-determined time criteria) and was either not accessed or was accessed and did not meet the pre-determined relevancy time criteria, may be degraded in the rankings or otherwise would get a non-relevant weight parameter. These parameters are stored in the search database 63. It will be appreciated, however, that the user-interaction parameter data stored in the search database may be stored in a separate data structure in the alternative.

Search engine 62 periodically updates the user interaction information stored in search database 63. As a consequence, over time, it is anticipated that search database 63 will develop a more useful indication of the longest accessed, and presumably most relevant documents represented by the records in the search database.

Various modifications may be made to the above-described embodiments consistent with the invention. The search engine techniques described herein may also be used locally for a given user or a group of specific users, rather than relying on the previous interactions by all users of a search engine. Moreover, the search engine may be implemented on an internal network, thus enabling, for example, a group of employees having related job functions to be the sole users through which user interaction data is tracked. Other manners of selecting a relevant set of users from which to obtain relevant user interaction information may also be used in the alternative.

Other modifications will be apparent to one of ordinary skill in the art. Therefore, the invention lies in the claims hereinafter appended.

The invention claimed is:

1. A method of accessing a database, the method comprising:
(a) in response to a search request, generating a result set including one or more records;
(b) in response to a user accessing a record of the result set, initiating a clock to time the duration of access by the user;
(c) for each of the one or more records, creating a user-interaction parameter associated therewith in response to the duration of time the record was accessed by a user; and
(d) ordering the identifications of the records in the result set using the user-interaction parameter associated with one or more records in the result set.

2. The method of claim 1, further including:
(e) selectively updating the user-interaction parameter associated with a first record in response to a determination that the duration of time a user accesses the first record exceeds a relevancy time period.

3. The method of claim 1, further comprising increasing the user-interaction parameter associated with a first record in response to the duration of time the first record is accessed exceeding a pre-determined relevancy time period.

4. The method of claim 1, further comprising detecting the rank of the one or more records of the result set and increasing the user-interaction parameter associated with a first record in response to the duration of time the first record is accessed exceeding a pre-determined relevancy time period relative to the user-interaction parameter of records having a higher rank that did not meet the relevancy time period.

5. The method of claim 4, wherein the relevancy time period not being met was because the record was not accessed.

6. The method of claim 1, wherein the step of initiating a clock to time the duration of access by the user is accomplished by a server having a search engine.

7. The method of claim 6, wherein generating the result set includes generating a plurality of hypertext links, each of which being configured to access the server to generate a notification that the associated record has been accessed by a user and to initiate the clock for the associated record.

8. The method of claim 1, wherein the step of initiating a clock to time the duration of access by the user is accomplished by a browser for the user.

9. The method of claim 8, wherein the browser comprises a clock and a means for detecting the navigation of the user away from a first record, the browser measuring the duration of time for the user accessing the first record to the initiation of the back key.

10. The method of claim 9 wherein the browser further comprises memory for maintaining the duration of time data for the first record, and wherein the step of initiating a clock to time the duration of access by the user further comprises periodically providing a notification to the search engine of the duration of time data.

11. A program product, comprising:
(a) a first program configured to, in response to a search request, generate a result set including identifications of a subset of a plurality of records in a database that match the search request, and to order the identifications of the records in the result set using a user-interaction parameter associated with each record in the result set;
(b) a second program configured to, for each record accessed of the plurality of records, determine the duration of time of access by the user of the record; and
(c) a signal bearing medium bearing the first and second programs.

12. The program product of claim 11, wherein the signal bearing medium includes at least one of a recordable medium and a transmission type medium.

13. The program product of claim 11, wherein the second program is implemented on a user's browser for conducting a search request.

14. A method of processing search requests submitted to a search engine, the method comprising:
(a) receiving a search request that specifies a plurality of keywords;
(b) generating a result set identifying a subset of identified records;
(c) for each of the identified records in the database, selectively updating a user-interaction parameter associated therewith in response to the duration of user interaction with the record exceeding a predetermined relevancy time period; and
(d) ordering the identifications of the subset of records in the result set using the user feedback parameter associated with each record in the result set.

15. The method of claim 14, further comprising detecting the rank of the one or more records of the result set and increasing the user-interaction parameter associated with a first record in response to the duration of time the first record is accessed exceeding a pre-determined relevancy time period relative to the user-interaction parameter of records having a higher rank that did not meet the relevancy time period.

16. The method of claim 15, wherein the relevancy time period not being met was because the record was not accessed.

17. The method of claim 1, wherein the step of selectively updating a user-interaction parameter associated therewith in response to the duration of user interaction with the record exceeding a predetermined relevancy time period further comprises initiating a clock to time the duration of access by the user.

18. The method of claim 17 wherein the step of initiating a clock is implemented by a program having a search engine.

19. The method of claim 17, wherein the step of initiating a clock is implemented by a user-based application.
